(19) United States
(12) Patent Application Publication
(10) Pub. No.: US 2006/0018200 A1
(43) Pub. Date: Jan. 26, 2006

(54) Mediwatch

(76) Inventors: Theresa Ann Pitocco, Glassboro, NJ (US); Michelle Christina Pitocco, Mantua, NJ (US)

Correspondence Address: THERESA ANN PITOCCO, 303 North Lehigh Road, Glassboro, NJ, 08028, US

(21) Appl. No.: 10/796,916

(22) Filed: Jul. 2, 2004

(51) Int. Cl. G04B 25/00; G04B 19/00

(52) U.S. Cl. 368/223

(57) ABSTRACT

A combined watch, storage container and a medical alert bracelet, thus eliminating the need for wearing a separate medical alert bracelet/necklace with separate alarms alerting the wearer when to take medication. The combined watch, pillbox storage container, with a locking device is hinged to the base, having a main face with four individual watch faces within. Control mechanisms fixedly mounted on the underside, of the lid and is adapted for tracking the time of day as well as the ability to set alarms independently and is powered by a battery. Fitting snuggly, the underside lid contains a two-sided removable disc for listing medications and important medical information. Storage device, which is the base housing, having bottom and peripheral walls coupled to and away from the peripheral edge and securely hinged to the lid. Storage device has multiple removable divisional inserts, allowing the choice for number of compartments with a plastic covered, rotating shield, which the wearer spins to open over the selected compartment. The underside engraved base serves as a medical alert bracelet with medical information permanently engraved

### BACKGROUND OF INVENTION

Being in the Medical Field, one was always challenged for ways to administer medication that would be patient compliant.

Having to be the caregiver to my disabled mother after she suffered a massive CVA, and now myself being disabled, I realized that it was and still is an on going problem when to take one's daily medications. Therefore, very often medication delivery was missed, especially during the times when one is away from home.

Though, I had a pillbox container, which stored the medicines for up to seven days at four daily intervals, remembering was still a problem. Not only did I have to carry the medication storage container; I had to have a separate alarm watch as a reminder. This became quite cumbersome and was certainly an inconvenience.

When comparing other such devices, which are similar, such as Daniel, U.S. Pat. No. 6,301,196, which incorporates the “silent alarm” and Danko, U.S. Pat. No. 5,802,014 which is a portable strap-on tablet dispensing system that hold a plurality of tablets, my invention is innovative and uniquely different which can only be concluded after examining the technical drawings and the detailed description of said operation.

Ghooahoo, U.S. Pat. No. 6,464,389, refers to a disc, which I believe to be describing the casement of the device. My usage of the word “disc” refers to a removable, changeable disc shaped insert, which fits into the underside of the lid of the pillbox. This disc is divided and lined for listing the medications stored in the base of the timepiece. This provides a “simple” way for identifying the medications in the pillbox/base. It also provides a readily available list of medications, which the wearer is taking.

Said important medication information does not require any special programming. This is simply a pop-out disc, held in position by a clear plastic shield surrounded by a ring frame. The flip side of this disc provides space for emergency contact information regarding the patient, such as name and phone number of physician, name and number to contact in case of an emergency, whether or not this patient has a living will or a medical directive, also able to be included is a specific medication alert, such as a blood thinner or steroid medication. This is so easy, that anyone can do it and medical personnel, such as their physician's nurse would be able to fill in the medication list disc in a timely manner not taking her away from her duties and responsibilities to her other patients.

Sandidge, U.S. Pat. No. 6,340,242 has an information-displaying, window, which is completely different from the removable information insert. This insert is user friendly and addresses the limitations of the senior population. They may not be able to program said information. Due to the usual deterioration of vision the big-faced watch measuring 2″ in diameter is most beneficial for the visually impaired. While eliminating the need to be able to view a small display window, it also addresses the problem of lost dexterity, and being unable to push small buttons. The only programming need to utilize and correctly operate this invention is to separately set one to four alarms as a reminder to take the medications carried in the watch/pillbox.

Furthermore, it is my intention to implore the pharmaceutical companies to provide a peelable medication label provided with their prescription that can be placed on a blank line in the appropriate section of the pop-out disc.

Another object of this invention is to address the issue of important medical information being readily accessible, but not complicated to retrieve. My device shall be engraved on the back of the base of the pill/box/storage compartment. This engraving can not be changed and eliminates the need to carry a separate medical alert card. Once again, no programming is needed.

Engraved information is information that will not change such as name, blood type, drug allergies and medical conditions. Please refer to the technical drawings for more detail.

It is the object to present to the general public a new “all-in-one” combined watch storage container and medical alert bracelet simple to operate encompassing the range of children to seniors. Young and old alike shall benefit from this invention.

Marketing will be geared so that all first responders will be educated to look for the MW symbol. Simplicity is the key here. Just flip open the lid and there is a list of the medications or turn the watch over and there is life saving medical information engraved.

This device is similar in some respects to previous patents, but much different because of its simplicity to operate and the combination of four important features.
1. the alarm watch
2. the medication storage capacity
3. the medication information list/important medical contact information
4. the medical alert engraving, replacing the need to wear a separate medical alert bracelet, or carry a medical identification card

Another object of this invention is to provide a new combination; watch/pillbox, with alarm reminders and a medical alert bracelet or information card to be manufactured and marketed.

It is the intention of the inventor, to keep this invention simple to operate and “:user friendly” which insures patient compliance, easily marketed and reasonably priced, so as to be affordable and operable to all potential users.

Another object of this invention is to give the consumer a choice to purchase a less complicated, more diverse medication storage/alarm watch combination, as well as eliminating the need to carry or wear separate medical alert information.

### BACKGROUND OF INVENTION

### 1. Field of Invention

The present invention relates to the field of watches with a duel function of:
a. multiple alarm watch
b. medication (pill) carrying/storing device

The timepiece is operated by an analog mechanism, which has either an audio or Silent (vibrating alarm.)

This present invention also relates to devices for providing medical information and personal identifying information combined with a timepiece/pillbox.

When compared to prior art, this invention is unique by its simplistic mode of operation.

When compared to prior art, this invention offers the consumer several choices with just the purchase of one mediwatch, because it has multi-divisional interchangeable compartments which provides the wearer the choice of the insert that best suits his/her needs. Marketing it with this diversity is the most cost-effective method for the consumer.

The present invention also relates to the field of medical alert bracelets/necklaces and medical information cards. When compared to prior art, this invention has permanently engraved medical information on the back of the base (pillbox) which no other prior art has. This eliminates the need to wear a separate medical alerting device.

### SUMMARY OF INVENTION

In view of the forgoing inherent disadvantages in the known types of medication storage devices with an alarm now present in the prior art the present invention provides a new and unique combination of alarm watch pill storage devices, and medical alert bracelets/necklaces/cards.

The general purpose of the present invention, which will be described subsequently in greater detail, is to provide a new multi-alarm watch, storage container which has many of the advantages of the strap on medication storage and reminder watches mentioned heretofore and many novel, unique features that result in a new alarm, medication storage watch device, which is not anticipated, rendered obvious, suggested, or even implied by any of the prior art strap-on medication storage and reminder watch either alone or in any combination thereof.

To attain this, the present invention generally comprises an alarm watch which includes a housing having a top wall, an opening in the top wall with a storage compartment that receives separate compartment divider inserts, consisting of two, three or four divisions, independent from the other. These inserts are removable and interchangeable. The housing includes a cover member hingedly attached with the cover member being essentially a timepiece having a clock face and four individual smaller clock faces within the main clock face. These smaller clock faces includes the reminder/alarm settings that coincides with the different compartments and also includes locking and releasing safety assembly for locking and releasing the cover member to and from the housing. The separate divider inserts having a rotating wheel shield that dials to a specific compartment, releasing the medication only in that compartment thus preventing the medications stored in the adjoining compartments from releasing.

The top housing having a second hinged cover, encasing a round shaped disc, which is enclosed in a ring, that snaps securely under the face of the watch which covers the alarm setting buttons and the battery. This disc is sectioned and numbered to coincide with the divider inserts and contains a list of the medications in each compartment, and on the flip side has written on it important emergency contact medical information.

The encasement cover, being the back of the base has permanently engraved medical information about the wearer of the watch.

There has thus been outlined rather broadly the more important features of the invention in order that the detailed description thereof that follows may be better understood, and in order that the present contribution to the art may be better appreciated. There are additional features of the invention which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new alarm watch, medication storage reminder combined with a medical alert system device to be easily manufactured and marketed.

Another object of the present invention is to provide a new multi-alarm watch/medication storage device, which is of durable and reliable construction.

Further on, the object of this present invention is to provide a multi-functional multi-purposed device which is susceptible of a low cost of manufacture with regard to both materials and labor and which accordingly is then susceptible of low prices of sale to the consumer, thereby making such a device economically attainable to the general buying public

Yet another object of the present invention is to provide a medication list disc in the embodiment of the medication storage device, to have readily available a list of all medications carried in the storage device, which fits into the underside of the lid of the pillbox/base. The disc is divided and lined for listing the medications.

An even further object of the present invention is the intent of the inventor to eliminate the need to wear a separate medical alert device.

Still another object of the present invention is to provide the wearer the freedom from worry about keeping tract of the time to take the medication doses through out the day, by signaling an alarm and opening a compartment to access the next dose of medicine.

Further still another object of the present invention is to have important medical information pertaining to the wearer, permanently engraved on the back of the base of the watch. This addresses the issue of having important medical information readily available, but not complicated to retrieve, with no programming required.

And further still another object of the present invention is to present to the general public a new “all-in-one” combined alarm watch/storage container and medical alert bracelet/necklace simple to operated and encompassing the range of children to seniors, promoting compliance.

Another object of the present invention is to have marketing geared so that all “first responders” will be educated to look for the “MW” symbol.

An yet another object is to offer diversity to the consumer with the removable insert dividers.

And still another object of the present invention is to keep the operation of this device simplistic. Simplicity is the key here. Just flip open the lid and there is a list of medications or turn the watch over and there is life saving medical information permanently engraved.

And still yet another object of the present invention is to attach the watch/storage device to a chain for wearing around the neck or for carrying in a pocket such as a neck watch and a pocket watch.

And yet a further object of the present invention is to have the watch/storage device clipped to be worn on a belt or of a similar nature.

One more object of the present invention is to provide a big faced watch to aid the visually impaired.

The present invention is similar in some respects to previous patents, but much different because of its simplicity to operate and the combination of four important features, which are the alarm watch, the medication storage, the medications list and the emergency contact information, plus the medical alert engraving, replacing the need to wear a separate medical alert bracelet/necklace or carry a medical identification card.

These together with other objects of the invention, along with the various features of novelty which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated preferred embodiments of the invention.

Therefore, the foregoing is considered as illustrative only of the principles of the invention. Further since numerous modifications and changes will readily occur to those skilled in the art, it is not desired to limit the invention to the exact construction and operation shown and described, and accordingly, all suitable modifications and equivalents may be resorted to, falling within the scope of invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

VIEW 1. Top view of main watch face showing the four smaller watch faces contained within.

VIEW 2. Side view of timepiece/storage container showing outer lid and Inner lid.

VIEW 3. Bottom side of the removable insert disc where medications stored In the base of the timepiece shall be listed.

VIEW 4. Front view of the timepiece/storage container in a closed position.

VIEW 5. Top side of removable insert disc, on which emergency medical Information is imprinted.

VIEW 6. Underside of top lid of timepiece showing alarm buttons, clock Setting button and battery compartment.

VIEW 7. Showing underneath portion of timepiece/storage container Showing area designated for engraving permanent medical I Information pertaining to the user.

VIEW 8. Showing removable insert with two compartments

VIEW 9. Showing removable insert with three compartments

VIEW 10. Showing removable insert with four compartments

VIEW 11. Showing dimensions of inserts

VIEW 12. Rotating shield covering showing opening for two compartments

VIEW 13 Removable insert with two compartments that receives rotating Shield with one opening for two compartments

VIEW 14. Rotating shield covering showing opening for three compartments.

VIEW 15. Removable insert that receives rotating shield cover for three compartments

VIEW 16. Rotating shield covering showing opening for four compartments

VIEW 17 Removable insert that receives rotating shield cover for four compartments

VIEW 18. Top of main watch face dimensions with dimensions pertaining to the four individual watch faces contained within

VIEW 19. Side view showing dimensions

VIEW 20. Back view showing dimensions including hinge placement

[image]

[image]

[image]

[image]

### DESCRIPTION OF THE PREFERRED EMODIMENT

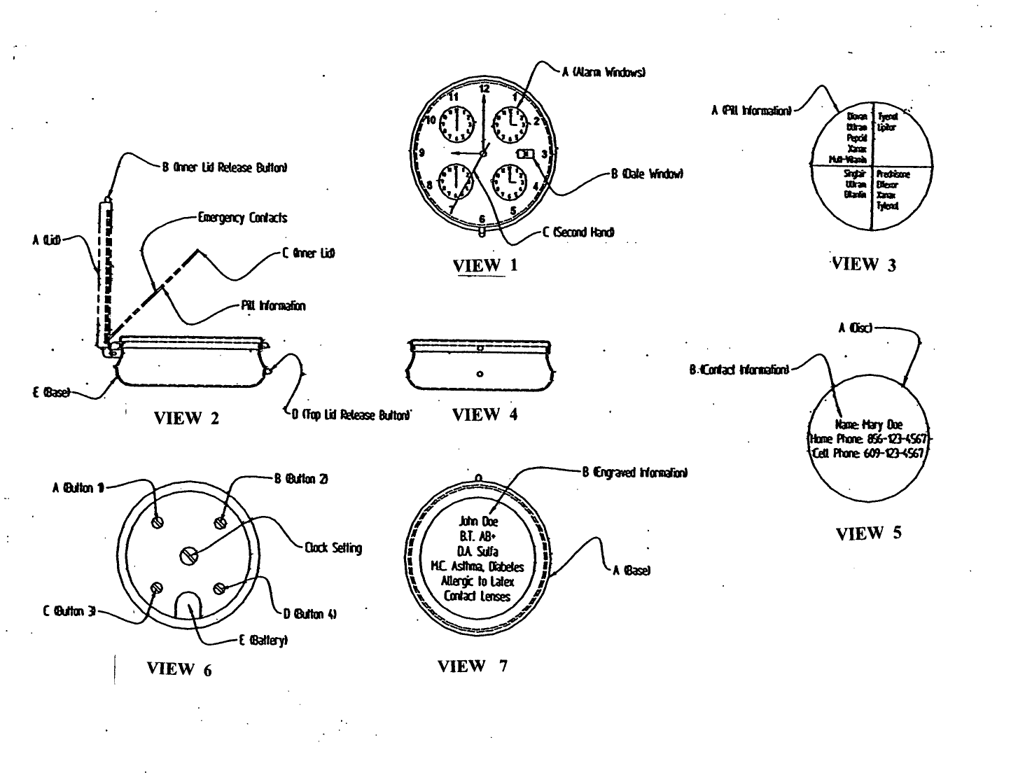

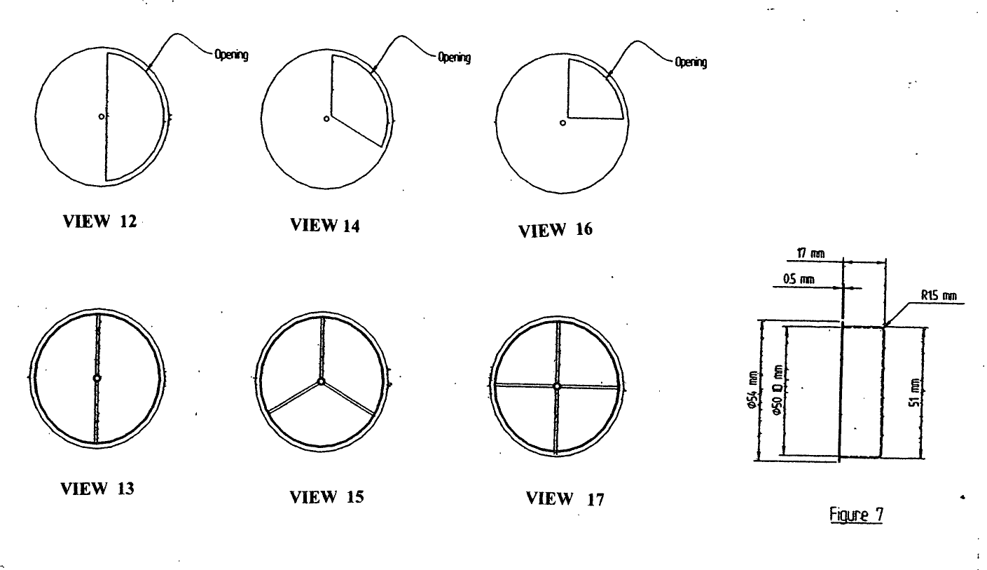

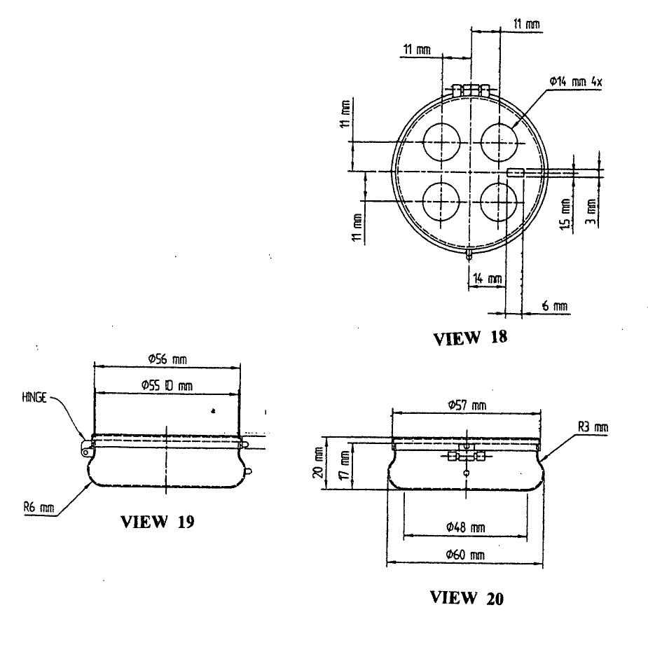

With reference now to the drawings and in particular to FIGS. 1 through 7, thereof a new combined analog alarm watch, storage container and medical alert device embodying the principals and concepts of the present invention and generally designated reference number 2 will be described.

As best illustrated in FIGS. 1, 2 and 7, the combined watch storage container and medical alert device generally comprises an alarm watch device 1 and a storage device 2 with four smaller watch faces 8, 9, 10, 11 contained within the main watch face 1, date window 12, second hand 13 and hour hands 14.

A housing having a circular shape 4 having and opening for receive removable divisional inserts 34, 36, 38 and a covered member 15, with a release button 16, h hingedly attached 17, to the housing 4, for releasability and securely closing over housing (base).

An inner lid 18, containing a disc 3, 5 encircled by a ring 19 containing topside of disc 20 for emergency contact information and bottom side of disc 21 for pill information held in place with an inner lid release button 22.

Bracket members 23 attached to cover member 15 and base housing 4 for securing chain 24, approximately 18 inches in length for wearing around users neck for a neck watch or for carrying in a pocket for a pocket watch/

Alarm type setting members depressibly and conventionally disposed in top wall 6, alarm setting button 25, for setting alarm one for alarm face 8, alarm setting button 26 for setting alarm two for alarm face 9, alarm setting button 27 for setting alarm face 10, alarm setting button 28 for setting alarm face 11 and further includes a power source 30, such as a battery removably and conventionally in inner top cover member 6 and a main face clock setting mechanism 29.

Bottom side of base 7, having a smooth surface 31, approximately having dimensions of 48 mm for engraving permanent medical information 32, pertaining to the user. The “MW” logo 33 engraved on watch face 33 to alert medical personnel that this is more than a watch.

A removable insert 34, that fits into opening of housing 4 with one divisional Wall 35 separating insert into two compartments. A removable insert 36, that fits into opening of said housing 4 with three divisional walls 37 separating insert into three compartments.

A removable insert 38 that fits into the opening of said housing 4, with two divisional walls 39 that separated the insert into four compartments

A rotating plastic cover/shield 40 showing one opening that is attached to the divider insert 34 showing two compartments. A rotating plastic cover/shield 41, showing one opening to accommodate the diver insert 35 showing three compartments. A rotating plastic cover/shield 42 showing one opening to accommodate insert 36 showing four compartments. The rotating covers snap snuggly over the divider inserts 34, 36, and 38 allowing the user to rotate the opening over a particular compartment to dispense the medication in that compartment only. Dimensions of rotating plastic covers with removable inserts 40.

Dimensional outline 44 of watch face covering member. Dimensional outline 45 showing radius, hinge and depth. Dimensional outline 46 showing radius, depth and width.

In use, medication is placed in storage device 2. Using buttons 25, 26, 27, and 28 to signal an alarm for a particular compartment. A list of this medication is contained in the inner lid 21 and emergency contact information 22. The back of the watch base/storage container 7 takes the place of having to wear a separate medical alert information bracelet/card.

As to a further discussion of the manner of usage and operation of the present invention, the same should be apparent from the above description. Accordingly no further discussion relating to the manner of usage and operation will be provided.

With respect to the above description then, it is to be realized that the optimum dimensional relationships for the parts of the invention to include variations in size, materials, shape, form function and manner of operation, assembly and use, are deemed readily apparent and obvious to one skilled in the are, and all equivalent relationships to those illustrated in the drawings and described in the specification are intended to be encompassed by the present invention.

Therefor, the foregoing is considered as illustrative only of the principles of the invention. Further, since numerous modifications and changes will readily occur to those skilled in the are, it is not desired to limit the invention to the exact construction and operation shown and described and accordingly, all suitable modifications and equivalents may be resorted to, falling within the scope of the invention.

What is claimed is:

1. An alarm watch combination pillbox with simplistic means of operation; of a circular shape with interchangeable multiple compartment divisions for storing/carrying at least one day's medications (pills) comprising of:
a circular shaped big-faced with date window, four separate alarm settings with small watch faces within the main watch face, battery operated analog watch device with multiple alarm function buttons on the underside of the watch face (lid) (four in all programmable for an alarm reminder indicating that it is time to take your medication
a housing have a top wall, an opening in said wall, which accepts removable multi-divisional compartment inserts, and being accessible through said opening in said top wall
a covered member being hingedly attached to said housing for release and securely closing over compartments of said housing, said housing further having means to attach to said chains or straps
a top covered member including a timepiece having a clock face with four smaller clock faces within the main clock face (for better comprehension, please refer to illustration sheet, page 1 FIG. 1), each clock face being independent of the other
a top covered member, housing the four alarm setting buttons on the underside of said covered member,
a top covered member housing the battery compartment on the underside of said covered member
a top covered member housing the clock setting button on the underside of said covered member
a second covered member which houses the medication list sticker disc and emergency contact information, encircled in a ring which is hingedly attached to said housing (please refer to illustration sheet 1 FIGS. 3 and 5)
a pill storage and reminder watch device as described above in claim 1, wherein said means for locking, releasing said top cover member includes a stub shaft being securely disposed in and extending from said bottom wall of said cover member near a perimeter thereof and also includes a bore extending trough said top wall of said housing adapted to receive said stub shaft being closed upon said housing and further includes a shaft ejecting member disposed inside bore of said housing and being biasedly-disposed toward a top a said housing and further includes a shaft release member depressibly disposed in a side wall of said housing and being abuttable against said shaft member for moving said shaft retaining member
a chain assembly mounted by brackets on said housing for securing said device around the neck of the wearer
a chain assembly mounted by brackets on said housing for securing said device to chain for carrying in pocket
a strap assembly mounted on said housing for securing said housing to the wrist of the wearer
control circuitry being adapted to the alarms independently of each other allowing each alarm to be programmed in one of four modes, talking, ringing buzzing or vibrating (silent).
this analog alarm watch mechanism which is battery operated with the battery being located in the underside of the watch face (lid).
this analog alarm watch mechanism, measuring approximately 2 inches in diameter, being hinged on one side, opening and closing with a safety security clasp.

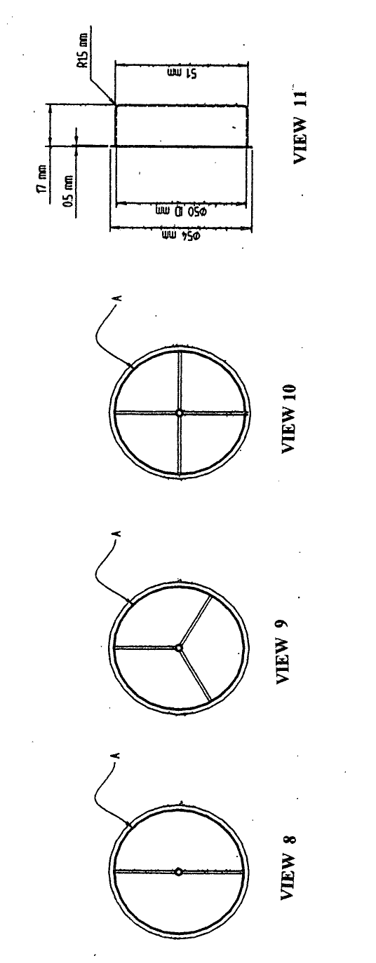

2. A medication identification list disc, which is hingedly attached to said housing, comprising of: (please refer to illustration sheet page 1 FIG. 2)
a plastic disc located between the lid and the pill compartment, surrounded by a metal ring which is used for adhering the contact information on the top side and medication information on the underside.
a second covered member as describe in claim 1, being hindedly attached to said housing
a removable, paper low adhesive sticker lined and sectioned for hand printing or typing the names of the medications stored in the base section, which can easily be “peeled out” for change or replacement.
a removable medication list sticker disc, which has numbered sections to coincide with the numbered compartments in the base, not connected to any circuitry or mechanisms, but simply placed on the underside portion of the watch face.
the back side of the removable paper sticker disc which is blank allowing patient to fill in information comprising of, but not limited to emergency and physician contact numbers, abbreviations “LW” indicating Living Will, “MD”, indicating Medical Directive, and “OD” indicating Organ Donor.

3. an alarm watch storage (pillbox) carrying device comprised of:
a base, which is a carrying/storing device for pills, having removable, interchangeable compartment divided inserts, not permanently attached to the inside of the base/pillbox, with each divisional insert being different from the other
a first dividing wall for dividing insert offering two compartments, said dividing wall has a first end and a second end each being fixedly coupled to said internal surface of insert peripheral wall, said first dividing wall generally extending along a line bisecting said insert
a second and third dividing wall for dividing said insert housing into three compartments.
a second dividing wall for dividing said insert, said second dividing wall has a first end and a second end each being fixedly coupled to said internal surface of said peripheral wall generally extending along a line bisecting said insert, said first dividing wall being orientated generally perpendicular to said second dividing wall, wherein said first and second dividing walls define four compartments
each divisional divider insert being separate and apart from any other insert, with each section/compartment being numbered to coincide with the alarm setting and to coincide with the medication list disc sections
each compartment insert snapping into said housing and being removable and changeable
plastic shield (lid) with a rotating opening to allow access to a specific compartment, being attached to a compartment divider insert.
wherein said covered portion has a size adapted to fit over said insert
a base having a safety clasp which lines up with the clasp on the watch portion and locks the device securely.
a base having an inside depth of ⅝ inch and 2 inches in diameter. (approximate)
a base of said housing having the outer bottom having a smooth surface for engraving with pertinent permanent medical information, such as but not limited to the wearer's name, blood type, medical conditions, drug allergies, implant information, other life threatening information, that if not available to first responders, could be fatal, such as an allergy to Latex, specific medication alert such as a steroid or a blood thinner, that in the event this information was not known could place the wearer in a life threatening situation, when emergency medical treatment or surgery is necessary,
an area for engraving that measures approximately 48 mm in diameter.
a base/pillbox watch combination with multiple alarm settings and a pluerity of interchangeable compartment divider inserts that as in claim 1 is attached to a strap or chain, to be worn on the wrist, around the neck (neck watch) or carried in a pocket (pocket watch), or attached to a hip clip that can be hooked onto a belt or anything of a similar nature.
